(19) United States
(12) Patent Application Publication
(10) Pub. No.: US 2026/0302272 A1
(43) Pub. Date: Oct. 1, 2026

(54) SOLID-OXIDE STACK STRUCTURE WITH IMPROVED COOLING

(71) Applicant: COMMISSARIAT A L'ENERGIE ATOMIQUE ET AUX ENERGIES ALTERNATIVES, Paris (FR)

(72) Inventors: Karl VULLIEZ, Grenoble Cedex 09 (FR); Manon ELIE, Grenoble Cedex 09 (FR); Thibault MONNET, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 19/474,050

(22) PCT Filed: Apr. 9, 2024
(86) PCT No.: PCT/FR2024/050463

§ 371 Date: Oct. 9, 2025

(30) Foreign Application Priority Data
Apr. 14, 2023 (FR) FR2303755

(51) Int. Cl. H01M 8/0267; H01M 8/0258; H01M 8/04014; H01M 8/12; H01M 8/1246; H01M 8/2432

(52) U.S. Cl. CPC H01M 8/0267; H01M 8/0258; H01M 8/04014; H01M 8/1246; H01M 8/2432; H01M 2008/1293

(57) ABSTRACT

The invention relates to a solid oxide stack structure (10) comprising an alternation, in a stacking direction Z, of electrochemical cells (12) and interconnection plates (14), each electrochemical cell (12) being formed by an electrolyte layer (18), an anode layer (20) and a cathode layer (22) disposed on either side of the electrolyte layer (18), in the stacking direction Z,
wherein each interconnection plate (14) that is located between two electrochemical cells (12) is in contact with the anode layer (20) of an electrochemical cell (12) and with the cathode layer (22) of the other electrochemical cell (12),
characterized in that at least one interconnection plate (14) includes at least one internal circuit (32) for circulating a fluid for regulating the temperature of the two electrochemical cells (12) that are in contact with the interconnection plate (14).

### TECHNICAL FIELD

The invention relates to a solid-oxide stack structure operating as an electrolyzer or as a fuel cell, which is designed to enable improved cooling of the elementary modules.

### PRIOR ART

An electrolyzer or solid-oxide fuel cell, commonly referred to as SOEC (Solid Oxide Electrolyzer Cell) or SOFC (Solid Oxide Fuel Cell), consists of an assembly of an electrolyte with two electrodes, which is clamped between two interconnection plates. The assembly is commonly referred to as an “electrochemical cell” and the interconnection plates are commonly referred to as “interconnectors”.

The electrolyzer, or fuel cell, thus consists of a stack of electrochemical cells and interconnectors.

The electrochemical reactions that take place at the core of the interconnector plates are either endothermic or exothermic. It is therefore important to control the temperature of the cells to ensure proper operation of the stack. This is particularly the case in the context of a high-temperature electrolyzer for which the formation of internal temperature gradients must be avoided.

Thus the development of industrial systems incorporating high-temperature electrolyzers involves an increase in the volume of gas processed and, consequently, an increase in the surface area and number of cells and the number of interconnector plates.

As a result, the thermal load applied to the systems is increased.

Document EP-3,171,438 describes a stack of a plurality of cells and interconnectors comprising cooling means in end interconnector plates of the stack.

These end plates are then thicker in order to contain the means for implementing cooling.

In the case of a multi-stack assembly, comprising a plurality of sub-stacks, or stacks, the cooling means are disposed in interconnector plates located at the ends of each sub-stack.

Thus, even if the number of interconnector plates comprising cooling means is increased in the case of a multi-stack assembly, the cooling of the cells located furthest away from the end plates may despite everything be insufficient.

The invention aims to provide a stack of cells and interconnector plates comprising means for directly cooling the cells, at any location on stack.

### DISCLOSURE OF THE INVENTION

The invention proposes a solid-oxide stack structure comprising an alternation, in a stacking direction Z of electrochemical cells and interconnection plates, each electrochemical cell being formed of an electrolyte layer, an anode layer and a cathode layer disposed on either side of the electrolyte layer, in the stacking direction Z, wherein each interconnection plate that is located between two electrochemical cells is in contact with the anode layer of one electrochemical cell and with the cathode layer of the other electrochemical cell, characterized in that at least one interconnection plate includes at least one internal circuit for circulating a fluid for regulating the temperature of the two electrochemical cells that are in contact with the interconnection plate.

Preferably, each interconnection plate includes an anode plate that is in contact with the anode layer of an electrochemical cell, a cathode plate that is in contact with the cathode layer of another electrochemical cell and a central plate located between the anode plate and the cathode plate, and said at least one internal circuit of an interconnection plate is formed in the central plate.

Preferably, the central plate further comprises anode ducts and cathode ducts for supplying the electrochemical cell with fluids.

Preferably, the anode ducts are formed hollow in a first face of the central plate, the cathode ducts are formed hollow in a second face of the central plate and said at least one internal circuit is formed hollow in either of the first face faces or the second face of the central plate.

Preferably, the central plate comprises a cooled plate in which said at least one internal circuit is formed and two intermediate plates distributed on either side of the cooled plate in which the anode ducts and the cathode ducts are formed.

Preferably, the anode ducts, the cathode ducts and said at least one internal circuit each consist of a cutout in the intermediate plate or the cooled plate.

Preferably, the cooled plate includes a central opening in which an insert is disposed.

Preferably, each internal circuit includes thermal ducts, at which heat transfers with the electrochemical cells that are in contact with the interconnection plate take place, fluid supply ports and supply ducts connecting the ports to the thermal ducts.

Preferably, the thermal ducts are formed in the insert and the feed ducts and feed ports are formed in the cooled plate.

Preferably, the thermal ducts are parallel to a longitudinal direction L, and the insert is received with clearance in the central opening with clearance in the longitudinal direction and without clearance in a transverse direction T.

Preferably, each interconnection plate includes two internal circuits that are mounted in series and the stack structure includes an interconnection bar connecting a supply port of an internal circuit to a supply port of the other internal circuit.

Preferably, each interconnection plate includes two internal circuits that are mounted in parallel.

Preferably, all the feed ports that have the same function are aligned in the stacking direction Z and are furthermore directly connected to each other.

### BRIEF DESCRIPTION OF THE DRAWINGS

FIG. 1 is a schematic perspective representation of a stack structure comprising an alternation of electrochemical cells and interconnection plates.

FIG. 2 is a schematic representation in detail and in exploded view showing an electrochemical cell disposed between two interconnection plates.

FIG. 3 is an exploded view in perspective in both directions with respect to the stacking direction of an interconnection plate according to a first embodiment of the invention.

FIG. 4 is a plan view and a view from below of the center plate of the interconnection plate shown in FIG. 3.

FIG. 5 is a larger-scale detail schematically showing the weld beads of the plates constituting the interconnection plate.

FIG. 6 is a perspective exploded view of an interconnection plate according to a second embodiment of the invention.

FIG. 7 is a plan view showing the cooled plate and insert shown in FIG. 6.

FIG. 8 is a schematic representation showing a series arrangement of the internal thermal regulation circuits.

FIG. 9 is a schematic representation showing a parallel arrangement of the internal thermal regulation circuits.

FIG. 10 is a plan view of an example embodiment according to another embodiment making it possible to mix two fluids in the internal thermal regulation circuit.

### DETAILED DISCLOSURE OF THE INVENTION

For the description of the invention, the orientations according to the reference frame S, L, T indicated in the figures corresponding respectively to a stacking direction Z, a longitudinal direction L and a transverse direction T will be adopted non-imitatively.

### General Description of a Stack Structure

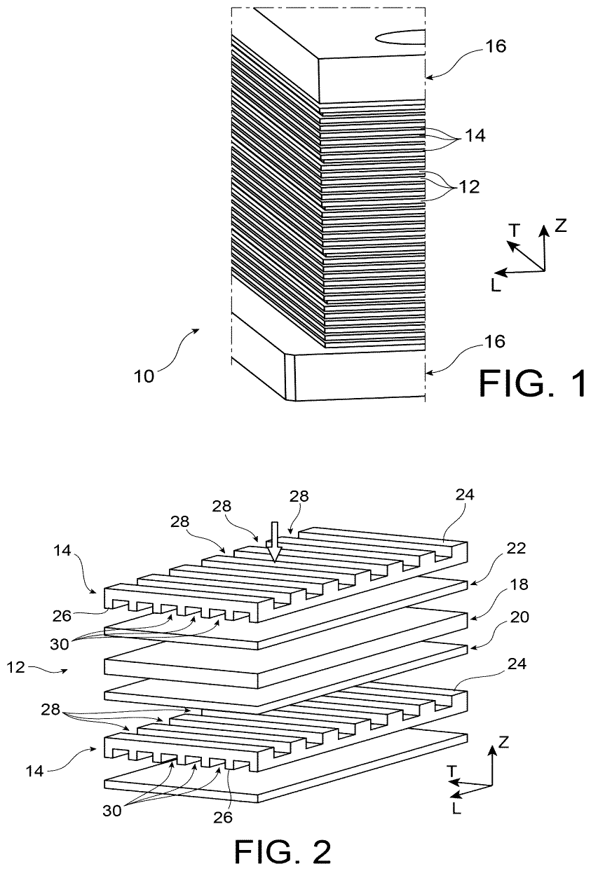

FIG. 1 shows a solid-oxide stack structure 10 which is composed of an alternation, in the stacking direction Z, of electrochemical cells 12 and interconnecting plates 14. The stack structure 10 also includes two terminal end plates 16 that are disposed at each of the ends of the stack structure 10, in the stacking direction Z.

As can be seen in more detail in FIG. 2, each electrochemical cell 12 comprises an electrolyte layer 18, an anode layer 20 and a cathode layer 22, the anode layer 20 and the cathode layer 22 being disposed on either side of the electrolyte layer 18, in the stacking direction Z.

Each electrochemical cell 12 is disposed between two interconnection plates 14 and each interconnection plate 14 is disposed between two electrochemical cells 12.

Therefore, each interconnection plate 14 includes an anode face 24 that is in contact with an anode layer 20 of an electrochemical cell 12 and includes a cathode face 26 that is in contact with a cathode layer 22 of a second electrochemical cell 12 that is located on the other side of the interconnection plate 14.

The interconnection plates 14 are electrical conductors that provide an electrical connection between the cathode layer 22 of an electrochemical cell 12 and the anode layer 20 of the other electrochemical cell 12. The interconnection plates 14 thus allow the flow of the electrical current from one electrochemical cell 12 to the other.

### Description of the Operation of a Cell

By way of non-limitative example, the operation of the stack structure 10 in operation in high-temperature steam electrolysis (SOEC mode) will be described below. In this operating mode, steam is broken down into hydrogen and oxygen under the effect of an electrical voltage.

Thus, for each electrochemical cell 12, oxygen passes through the electrolyte layer 18 to be discharged by the anode layer 20, while the hydrogen is discharged at the cathode layer 22.

The interconnection plates 14 also have the function of enabling the flow of gases intended to react in the electrolytic cells 12. For this purpose, each anode face 24 includes anode ducts 28 and each cathode face 26 includes cathode ducts 30.

The cathode ducts 30 are thus supplied with steam (H₂O) and a mixture between the hydrogen produced and the rest of the steam which has not reacted emerges. The anode ducts 28 are for their part supplied by a draining gas, and a mixture between the draining gas and the oxygen produced emerges from it.

### Basic Structure of an Interconnection Plate

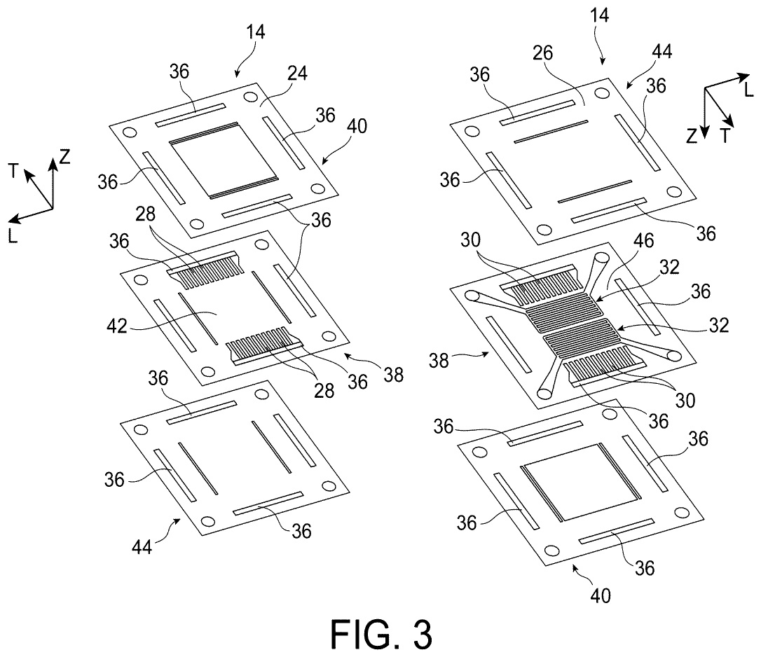

As can be seen in more detail in FIG. 3, an interconnection plate 14 is made in three parts, forming a multilayer structure, namely a central plate 38 comprising the anode ducts 28 and cathode ducts 30, an anode plate 40 covering a first face 42 of the central plate 38, on which the anode ducts 28 are formed, and a cathode plate 44, covering a second face 46 of the central plate 38, on which the cathode ducts 30 are formed.

The anode plate 40 comprises the anode face 24 of the interconnection plate 14, which comes into contact with the anode layer 20 of the electrochemical cell 12 and the cathode plate 44 comprises the cathode face 26 of the interconnection plate 14, which comes into contact with the cathode layer 22 of the electrochemical cell 12.

The anode ducts 28 are formed hollow on the first face 42 of the central plate and consist, for example, of hollow grooves. Similarly, the cathode ducts 30 are formed hollow on the second face 46 of the central plate 38 and consist of hollow grooves.

The interconnection plate 14 also includes openings 36 for connecting the ducts 28, 30. The openings 36 are preferably formed in the three plates 38, 40, 44 constituting it.

According to a preferred but non-limitative embodiment, the interconnection plate 14 has a rectangular and preferably square main shape the edges of which are parallel to the longitudinal direction L or to the transverse direction T.

Each of the three plates 38, 40, 44 thus includes two connection openings 36 which are associated with the anode ducts 28. These two openings 36 are parallel to the longitudinal direction L and each longitudinal opening 36 is located along one of the two opposite longitudinal edges of the interconnection plate 14.

Each of the three plates 38, 40, 44 also includes two connection openings 36 which are associated with the cathode ducts 30. These two openings 36 are parallel to the transverse direction T and each transverse opening 36 is located along one of the two opposite transverse edges of the interconnection plate 14.

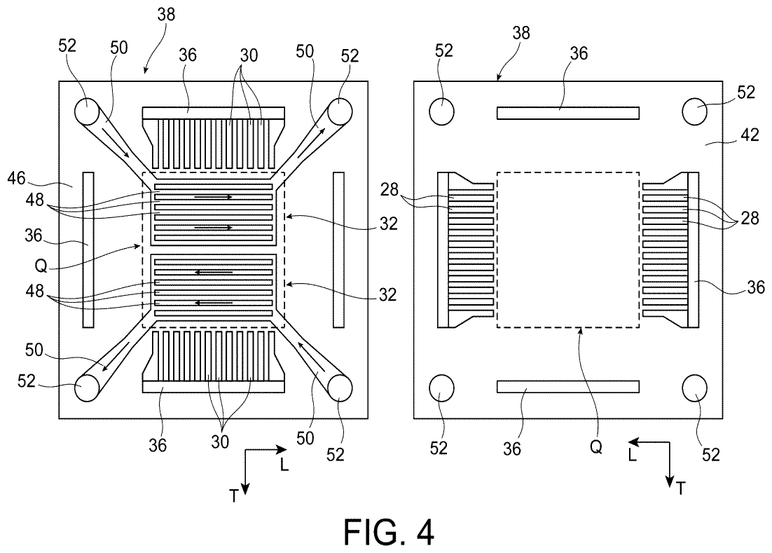

Thus, the dimensions of the interconnection plate 14, in the plane thereof, i.e. perpendicular to the stacking direction Z, are greater than the dimensions of the electrochemical cell 12. The electrochemical cell 12 is arranged in the center of the interconnection plate, as shown by the quadrilateral Q in broken lines in FIG. 4.

Here, and according to a preferred but non-limitative embodiment, the anode ducts 28 extend in a straight line and in the transverse direction T from a longitudinal opening 36 to the electrochemical cell 12 and the cathode ducts 30 extend in a straight line and in the longitudinal direction L from a transverse opening 36 to the electrochemical cell 12.

The anode plate 40 and the cathode plate 44 are secured to the first face 42 and to the second face 46 of the central plate 38, respectively, for example by welding so as to close the anode ducts 28 and the cathode ducts 30 at their opening in the stacking direction and thus isolate each duct 28, 30 sealingly.

### General Principle of the Invention: Cooled Interconnection Plate

Whether the stack structure 10 operates as an electrolyzer or as a fuel cell, temperature management of the electrochemical cells 12 is important.

For this purpose, at least one interconnection plate 14, and preferably each interconnection plate 14, includes, in addition to the anode ducts 28 and the cathode ducts 30, at least one internal circuit 32 for circulating a fluid for regulating the temperature of the two electrochemical cells 12 that are in contact with the interconnection plate 14.

Preferably, the interconnection plate 14 comprises two internal temperature regulation circuits 32, namely an internal cooling circuit and an internal heating circuit 32. According to a variant embodiment, the interconnection plate 14 includes a single internal temperature regulation circuit 32, which is suitable for use for heating or cooling the electrochemical cells 12.

Each of these internal circuits 32 is isolated from the anode ducts 28 and the cathode ducts 30 in order to avoid any mixing of the different fluids.

In the following description, reference will be made to an interconnection plate comprising two internal temperature regulation circuits 32. It will be understood that the variance embodiment according to which the interconnection plate 14 includes a single internal temperature regulation circuit 32 can be deduced by similarity.

As can be seen in more detail in FIG. 4, each internal temperature regulation circuit 32 includes thermal ducts 48 at which heat transfers between the interconnection plate 14 and the electrochemical cells 12 take place. These thermal ducts 48 extend in a zone geometrically corresponding to the electrochemical cell 12 in order to be located, in the stacking direction Z, at the electrochemical cell 12. As can be seen in FIG. 4, the thermal ducts 48 are included in the dashed quadrilateral Q corresponding to the electrochemical cell 12.

Each internal temperature regulation circuit 32 also includes supply ducts 50 through which the thermal regulation fluid is led to or out of the thermal ducts 48.

Finally, the interconnection plate includes supply ports 52 for thermal regulation fluid to which the supply ducts 50 of the internal circuits 32 are connected.

Here, the supply ports 52 are arranged at each corner of the interconnection plate 14 and are circular in shape. This arrangement makes it possible to adapt the connection of the interconnection plate 14 with thermal regulation fluid without having to modify the arrangement or the shape of the connection openings 36 associated with the anode ducts 28 and the cathode ducts 30. It will be understood that this embodiment is not limitative and that another form or arrangement of the supply ports 52 is possible.

The internal thermal regulation circuits 32 are thus designed not to reduce the efficiency of the supply of the electrochemical cell with elements necessary for its operation by the anode ducts 28 and the cathode ducts 30.

### One-Piece Central Plate

As can be seen in FIGS. 3 and 4, according to the first embodiment, the central plate 38 of the interconnection plate 14 consists of a single plate on which the anode ducts 28, the cathode ducts 30, and the internal temperature regulation circuits 32 are formed.

As described previously, the anode ducts 28 and the cathode ducts 30 are formed hollow in the first face 42 or the second face 46 of the central plate 38.

The internal temperature-regulation circuits 32 are also formed hollow on either of the first face 42 or the second face 46 of the central plate 38, here on the second face 46 of the central plate 38.

One advantage of this embodiment lies in the fact that manufacturing the central plate 38 only requires an additional machining step compared with a central plate 38 not comprising an internal temperature regulation circuit 32.

By way of non-limiting example, the thickness of the central plate 38 is between 0.4 and 1 mm.

The various ducts 28, 30, 50, 52 are formed by mechanical processes of the milling, electro-erosion, additive manufacturing deposition, or gluing of a pre-machined plate type.

The depth of the ducts 28, 30, 50, 52 is preferably less than half the thickness of the central plate 38.

As indicated previously, the securing of the anode plate 40 and the cathode plate 44 with the central plate 38 is carried out to sealingly insulate the anode ducts 28, the cathode ducts 30, and the internal temperature regulation circuit 32, thus forming independent chambers. This securing is preferably carried out by welding the plate 40, 44 with the central plate 38.

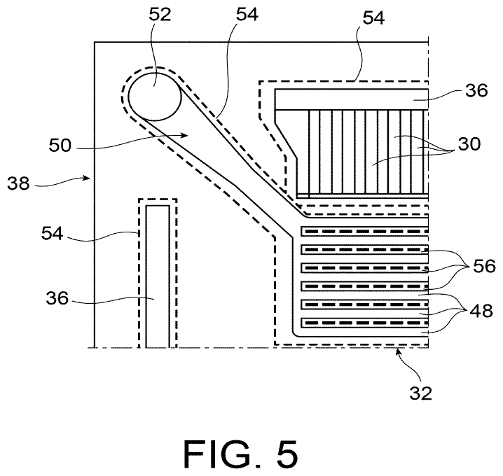

As can be seen in FIG. 5, a continuous and fluidtight weld bead 54 is formed around each chamber constituting the anode ducts 28, the cathode ducts 30, and the internal temperature regulation circuit 32.

Discontinuous weld beads 56 may be formed between the ducts of one of these chambers. The main function of these discontinuous weld beads 56 is to ensure mechanical holding of the assembly of the plates 38, 40, 44 together.

### Multi-Piece Central Plate

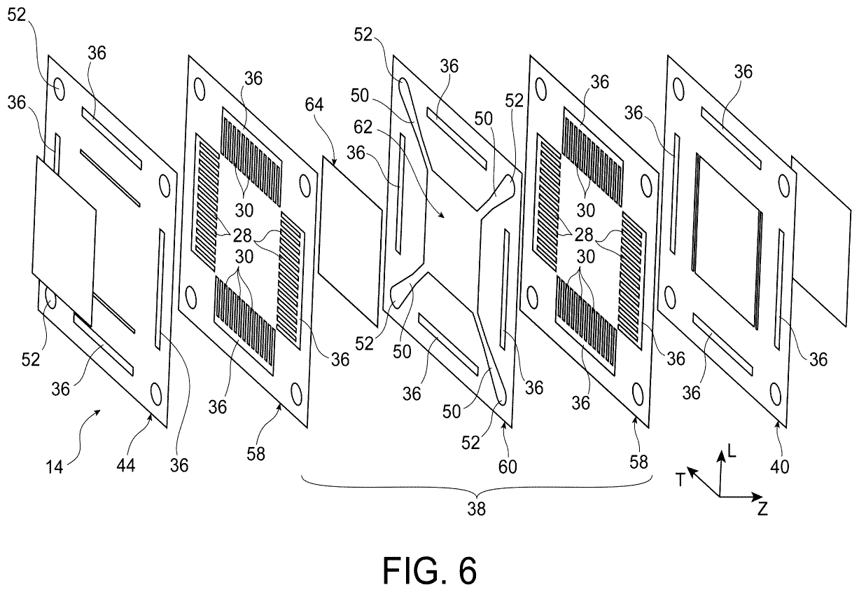

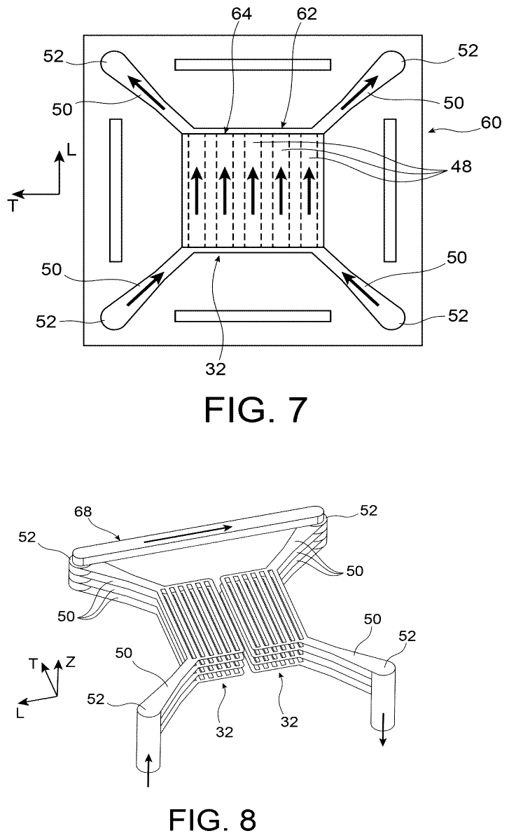

FIGS. 6 and 7 show a second embodiment of an interconnection plate 14 comprising an internal circuit 32 for thermal regulation.

According to this second embodiment, the interconnection plate 14 includes an anode plate 40 and a cathode plate 44 similar to those of the embodiment described previously. The interconnection plate 14 also includes a central plate 38 which here is made of several components superimposed in stacking direction Z.

The central plate 38 is thus itself composed of two intermediate plates 58 disposed on either side of a cooled plate 60.

The intermediate plates 58 are substantially identical to each other and both comprise anode ducts 28 and cathode ducts 30. The anode ducts 28 or the cathode ducts 30 of an intermediate plate 58 are suitable for being connected or not to a fluid circuit.

The use of identical intermediate plates 58 makes it possible to reduce the number of part references to be used and also to simplify the assembling of the interconnection plate 14 and therefore of the stack structure 10.

Preferably, the anode ducts 28 and the cathode ducts 30 consist of recesses formed in each intermediate plate 58, i.e. they are open at each face of the intermediate plate 58. The anode ducts 28 and the cathode ducts 30 are preferably delimited, in the stacking direction Z, by the anode plate 40 or the cathode plate 44 on the one hand and by the cooled plate 60 on the other hand.

Continuous weld beads 54 and, where applicable, discontinuous weld beads 56 as described previously make it possible to seal the anode ducts 28 and the cathode ducts 30.

The cooled plate 60 includes a central opening 62, supply ducts 50 which enable the thermal regulation fluid to be conveyed to the central opening 62, and supply ports 52. Similarly to the first embodiment, each supply port 52 is located at a corner of the cooled plate 60 and each supply duct 50 extends from a supply port 52 which is associated with it as far as the central opening 62.

Similarly to the intermediate plates 58, the central opening 62, the supply ducts 50 and the supply ports 52 are formed by a cutout in the cooled plate 50, i.e. they are open at each face of the cooled plate 50. When the central plate 38 is assembled, the central opening 62, the supply ducts 50 and the supply ports 52 are delimited, in stacking direction Z, by the two intermediate plates 58 which are fastened on either side of the cooled plate 60.

According to the embodiment shown, the central opening 62 receives an insert 64, shown in FIG. 7, in which the thermal ducts 48 are formed. The dimensions of the insert 64 and the central opening 62 are defined to allow a supply of the insert 64 with thermal regulation fluid, i.e. the insert 64 is received in the central opening 62 with a clearance on either side in the longitudinal direction L of the thermal ducts 48 and the insert 64 is received without clearance in the opening in the transverse direction T.

### Examples of Application

Regardless of the embodiment of the central plate 38, in a single piece or in several plates, it will be understood that the structure of the thermal ducts 48 and in particular the arrangement of the internal circuits 32 of one and the same interconnection plate 14 with respect to one another and/or with respect to the internal circuits 32 of the other interconnection plates 14 can have different embodiments without departing from the invention.

### Mounting in Series

According to a first example shown in FIG. 8, the internal circuits 32 of each interconnection plate 14 are mounted in series. Thus, as can be seen by the arrows in this figure, the thermal regulation fluid enters an interconnection plate 14 through a first supply port 52, passes through a first internal circuit 32, exits through a second supply port to enter again into the same interconnection plate 14 through a third supply port 52, supplies the second internal circuit 32 and exits the interconnection plate 14 through a fourth supply port 52.

To enable a series connection of the internal circuits 32, the second supply port 52 of an internal circuit (32) is connected to the third supply port 52 of the other internal circuit (32) an interconnection bar 68.

### Mounting in Parallel

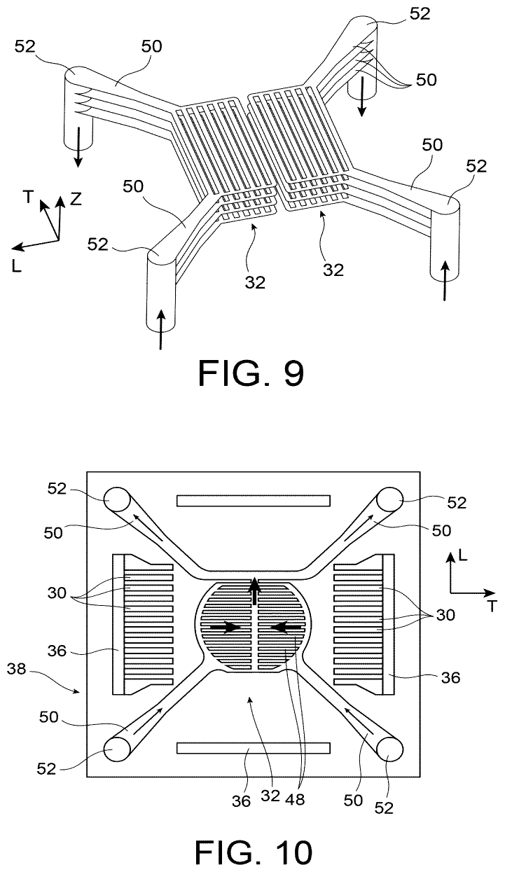

According to a second aspect shown in FIG. 9, the internal circuits 32 of each interconnection plate 14 are mounted in parallel. Thus, as can be seen by the arrows in this figure, the thermal regulation fluid enters an interconnection plate 14 through a first supply port 52, passes through a first internal circuit 32 and exits through a second supply port 52. Similarly, the same fluid or another fluid enters the same interconnection plate 14 through a fourth supply port 52, supplies the second internal circuit 32 and exits the interconnection plate 14 through the third supply port 52.

Here also, all the first supply ports 52 of all interconnection plates 14 are aligned in the stacking direction Z and are connected to each other. The same applies to the second, third and fourth supply ports 52.

According to this second aspect, the internal circuits 32 associated with the first supply ports 52 and the second supply ports 52 are independent of the internal circuits 32 associated with the third supply ports 52 and the fourth supply ports 52.

This second aspect makes it possible to form two circuits of thermal regulation fluids independent of one another.

Thus, it is possible to circulate a first fluid intended for example for cooling the electrochemical cells in one of these two circuits and a second fluid intended for example for heating the electrochemical cells in the other of these two circuits.

### Mounting for Mixing Fluids

FIG. 10 shows another example of implementation of the invention in which the thermal ducts 48 are grouped in a single internal circuit 32. This internal circuit 32 is supplied by two different fluids, here a fluid supplied by the first supply port 52 and a fluid supplied by the fourth supply port 52.

These two fluids mix in the internal circuit 32 and react chemically by mixing to produce an exothermic or endothermic reaction. The product of this chemical reaction is discharged through the two other supply ports 52.

According to yet another aspect of the stack structure 10, the interconnection plates 14 are arranged parallel to one another and are aligned in the stacking direction Z. Preferably, they all have the same orientation in this stack, so that all the supply ports 52 that have the same function are aligned in the stacking direction Z and so that they are furthermore directly connected to one another.

Thus, as can be seen in FIGS. 8 and 9, all the first supply ports 52 of all the interconnection plates 14 are aligned in the stacking direction Z and are connected to each other. The same applies to the second, third and fourth supply ports 52.

Furthermore, as shown in FIG. 8, in the case of a series mounting of the internal ducts 32, the assembly formed by all the second supply ports 52 is connected to the assembly formed by the third supply ports 52 by a single interconnection bar 68.

1.-10. (canceled)

11. A solid oxide stack structure, comprising:
an alternation, in a stacking direction, of electrochemical cells and interconnection plates, each of the electrochemical cells being formed by an electrolyte layer, an anode layer and a cathode layer, disposed on either side of the electrolyte layer, in the stacking direction,
wherein each of the interconnection plates that is located between two of the electrochemical cells is in contact with the anode layer of one of the two electrochemical cells and with the cathode layer of the other of the two electrochemical cell,
wherein at least one of the interconnection plates includes at least one internal circuit for circulating a fluid for regulating a temperature of the two electrochemical cells that are in contact with the at least one of the interconnection plates,
wherein each of the interconnection plates includes an anode plate that is in contact with the anode layer of one of the electrochemical cells, a cathode plate that is in contact with the cathode layer of another one of the electrochemical cells, and a central plate located between the anode plate and the cathode plate,
wherein the central plate of the interconnection plate includes the at least one internal circuit,
wherein the central plate further includes anode ducts and cathode ducts for supplying the electrochemical cells with fluids,
wherein the central plate is a one-piece plate, and
wherein the anode ducts are formed hollow in a first face of said one-piece central plate, the cathode ducts are formed hollow in a second face of the one-piece central plate and the at least one internal circuit is formed hollow in either of the first face or the second face of the one-piece central plate.

12. The stack structure according to claim 11, wherein the at least one internal circuit comprises thermal ducts, at which heat transfers with the electrochemical cells that are in contact with the interconnection plate take place, fluid supply ports and fluid supply ducts connecting the fluid supply ports to the thermal ducts.

13. The stack structure according to claim 12, wherein the thermal ducts are parallel to a longitudinal direction, and wherein an insert is received with clearance in the central opening with clearance in the longitudinal direction and without clearance in a transverse direction.

14. The stack structure according to claim 12, wherein each of the interconnection plates includes two internal circuits as the at least one internal circuit, wherein the two internal circuits are mounted in series and wherein the stack structure includes an interconnection bar connecting one of the fluid supply ports of one of the two internal circuits to one of the fluid supply ports of the other of the two internal circuits.

15. The stack structure according to claim 11, wherein each of the interconnection plates includes two internal circuits as the at least one internal circuit, and wherein the two internal circuits are mounted in parallel.

16. The stack structure according to claim 12, wherein all of the fluid supply ports that have a same function are aligned in the stacking direction Z and are furthermore directly connected to each other.
